(19) United States
(12) Patent Application Publication
(10) Pub. No.: US 2008/0173157 A1
(43) Pub. Date: Jul. 24, 2008

(54) Fastening dock structure for drums

(76) Inventor: Tsun-Chi Liao, Taichung City (TW)

Correspondence Address: Joe McKinney Muncy, PO Box 1364, Fairfax, VA, 22038-1364, US

(21) Appl. No.: 11/654,629

(22) Filed: Jan. 18, 2007

(51) Int. Cl. G10D 13/02

(52) U.S. Cl. 84/421

(57) ABSTRACT

A fastening dock structure for drums includes a dock body which is fastened to an outer side of a shell of a drum, a batter head located on the top surface of the drum, a counterhoop on the periphery of the batter head, and a collar on an outer side of the counterhoop. The collar has a bucking rim pressing the counterhoop and longitudinal through holes on the outer side to be fastened respectively by a fastening element. The fastening element has a distal end fastened to the dock body by screwing. The dock body has a longitudinal aperture to hold a bushing. The bushing has a screw hole inside surrounding by an elastic element having a contracting hole at the top portion smaller than screw hole to be fastened by the fastening element. Thereby the dock body can absorb vibration and the fastening element can be prevented from loosening.

### FIELD OF THE INVENTION

The present invention relates to a drum fastening dock and particularly to a fastening dock structure for drums to tighten the batter head and form a firm coupling and absorb vibration.

### BACKGROUND OF THE INVENTION

A conventional drum, referring to FIG. 1, mainly includes a drum body 1 which has a tightened batter head 2 on the top surface surrounding by a counterhoop 3 and a shell 4 with a fastening dock 5 located on the periphery. The fastening dock 5 has a plurality of round holes located annularly to be coupled with metal bushings 6 each has a screw hole formed therein. A metal collar 7 is provided which has a bucking rim 8 on an inner side to straddle from up and down the counterhoop 3. The collar 7 has a plurality of through holes on an outer side to receive respectively a bolt 9 which has a distal end fastened to the screw hole of the metal bushing 6.

When the batter head 2 is struck by drumsticks for a prolonged period of time, it gradually loosens. Hence the bolt 9 has to be fastened to move the collar 7 and the counterhoop 3 downwards to tighten the batter head 2.

When drummers strike the batter head 2 with the drumsticks, the metal collar 7 will occasionally be hit by the drumsticks. The bolt 9 fastened to the collar 7 generates vibration which is transmitted to the metal bushing 6. The bolt 9 tends to loosen, and the batter head 2 also gradually loosens. On the other hand the vibration wave is transmitted to the batter head 2 and affects the acoustic effect generated by the vibration of the batter head 2.

### SUMMARY OF THE INVENTION

The primary object of the present invention is to provide a fastening dock structure for drums that has a metallic dock body fastened to an outer side of a shell of a drum, a batter head on the top surface of the drum, a counterhoop surrounding the batter head and a circular collar on the periphery of the counterhoop. The collar has a bucking rim on an inner side to press the counterhoop and a plurality of longitudinal through holes on an outer side to be fastened by a fastening element which has a distal end fastened to the dock body. The dock body has an aperture to couple with a bushing which has a screw hole formed inside and is encased by a plastic elastic element. Therefore when the batter head is struck by drummers the fastening element does not loosen and the elastic element can absorb vibration so that the acoustic effect generated by the batter head is not affected.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary sectional view of a conventional drum with the batter head tightened.

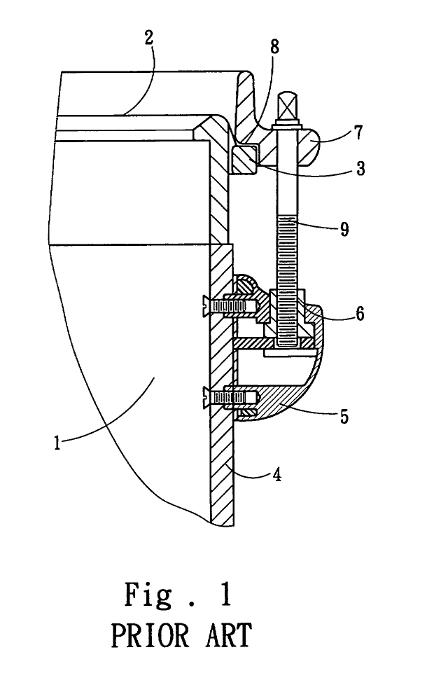

FIG. 2 is an exploded view of an embodiment of the invention.

FIG. 3 is a fragmentary sectional view of the invention coupling with a drum.

FIG. 4 is a perspective view of the invention coupling with a drum.

### DETAILED DESCRIPTION OF THE PREFERRED EMBODIMENT

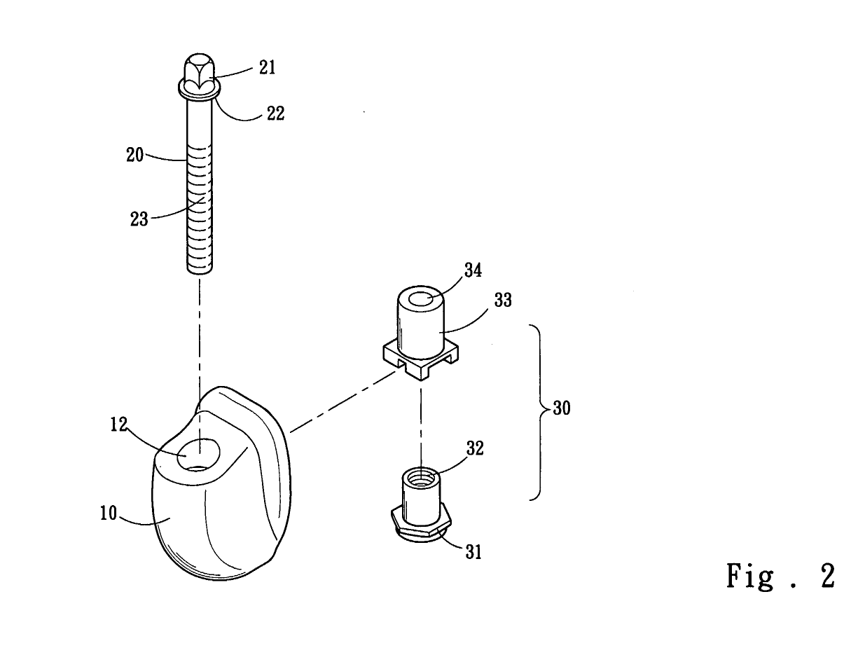

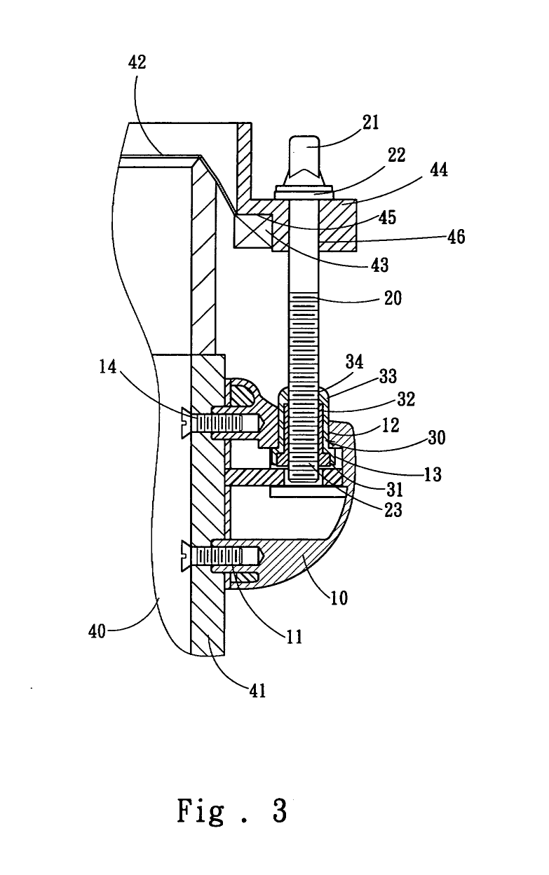

Please refer to FIGS. 2 and 3, the fastening dock for drums according to the invention includes:

a dock body 10 which is made of metal and hollow inside, and has a pair of screw holes 11 on an upper side and a lower side, a circular aperture 12 formed longitudinally from the top and a pair of retaining troughs 13 formed beneath the aperture 12 directing towards the front side and rear side;

a strut type fastening element 20 (such as a bolt) which has a polygonal head 21 on an upper side, a detent ring 22 below the head 21, and a threaded portion 23 on a lower side. The peripheral size of the detent ring 22 is greater than the diameter of the threaded portion 23; and

a bushing 30 which is cylindrical and held in the aperture 12, and has a polygonal coupling head 31 on a lower side and a metallic interior with a screw hole 32 formed in the center. It is encased by a plastic elastic element 33 which is extended outside the coupling head 31 so that the coupling head 31 becomes a square and held in the retaining trough 13. The top portion of the elastic element 33 is extended above the screw hole 32 at a selected distance. The top portion of the screw hole 32 forms a contracting hole 34 at a diameter smaller than the screw hole 32.

By means of the construction set forth above, for assembly, the screw hole 11 of the dock body 10 is fastened by a screw 14 running from the inner side of the shell 41 outwards so that the dock body 10 is fastened to the periphery of the shell 41. The drum 40 has a batter head 42 on the top portion that is surrounded by a counterhoop 43. The counterhoop 43 is coupled with a metallic collar 44 on an outer side. The collar 44 has a bucking rim 45 on an inner side and a plurality of longitudinal through holes 46 on the periphery.

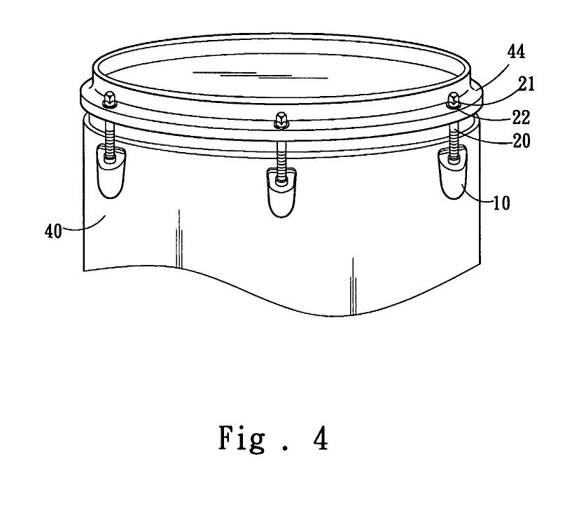

Next, couple the bushing 30 in the aperture 12 with the coupling head 31 and insert into the retaining troughs 13 to prevent the bushing 30 from swiveling. The top portion of the bushing 30 can be extended above the dock body 10. The fastening element 20 runs through from up and down the through hole 46 on the periphery of the collar 44 and is engaged forcefully with the contacting hole 34. The detent ring 22 of the fastening element 20 presses the upper side of the collar 44. The threaded portion 23 at the distal end of the fastening element 20 is engaged with the screw hole 32 of the bushing 30 to force the bucking rim 45 of the collar 44 to press the counterhoop 43 at the batter head 42 so that the batter head 42 is tightened. After the batter head 42 has been struck for a period of time and become loose, the fastening elements 20 can be fastened to tighten the batter head 42 again as shown in FIG. 4. Thereby the acoustic effect of the drum can be tuned as desired.

As the bushing 30 is made from plastics on the periphery and is elastic, it can absorb vibration. The contracting hole 34 can be coupled tightly with the fastening element 20 due to forceful coupling. And the elastic element 33 surrounding the bushing 30 is coupled with the aperture 12 of the dock body 10, hence when the collar 44 is hit by drumsticks, vibration waves are transmitted to the fastening elements 20 and absorbed by the contracting hole 34. Residual vibration waves are transmitted to the distal end of the fastening elements 20 and absorbed by the elastic element 33. Thus impact of the vibration to the dock body 10 is greatly reduced. And the acoustic effect generated by the batter head 42 struck by the drumsticks can be maintained as desired.

In addition, the elastic element 33 surrounding the bushing 30 cab be squeezed due to its elasticity, and can be inserted by force into the aperture 12. The contracting hole 34 also can be tightly coupled with the fastening element 20. All this can absorb the vibration and prevent loosening of the fastening element 20 that might otherwise occur due to the vibration.

Prototypes of the invention have been made according the description and drawings of the invention. Test results prove that the objects and function are fully accomplished. While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A fastening dock structure for drums, comprising:
a dock body surrounding a shell of a drum, a batter head located on a top portion of the drum, a counterhoop on the periphery of the batter head and a collar surrounding an outer side of the counterhoop; the collar having a bucking ring on an inner side to press the counterhoop and a plurality of longitudinal through holes on the periphery, the dock body being hollow and having an aperture formed therein longitudinally from the top thereof, the aperture having a pair of retaining troughs on a lower side directing towards a front side and a rear side;
a strut type fastening element which has a head on an upper side, a detent ring beneath the head and a threaded portion on a lower side; the detent ring having a periphery greater than the diameter of the threaded portion, the fastening element running through the through hole of the collar and having the detent ring located above the collar; and
a bushing which has a cylindrical upper end held in the aperture of the dock body and a metallic interior which has a screw hole formed therein to be fastened by the fastening element and a polygonal coupling head extended from a lower end; the bushing being encased by a plastic elastic element which is extended to the periphery of the coupling head such that the coupling head becomes square to be held in the retaining trough of the dock body, the elastic element having a top portion extended above the screw hole at a selected distance such that the top portion of the screw hole forms a contracting hole at a diameter smaller than the screw hole.

2. The fastening dock structure for drums of claim 1, wherein the dock body has a pair of transverse screw holes on an inner side at an upper and lower side to be fastened respectively by a screw running outwards from the interior of the shell.

3. The fastening dock structure for drums of claim 1, wherein the head of the fastening element is polygonal.
